(19) United States
(12) Patent Application Publication
(10) Pub. No.: US 2025/0180428 A1
(43) Pub. Date: Jun. 5, 2025

(54) METHODS AND SYSTEMS FOR GUIDING CORROSION SURVEYS OF UNDERGROUND PIPELINE

(71) Applicant: American Innovations, Ltd., Austin, TX (US)

(72) Inventors: Andrew HOLLE, Austin, TX (US); Jerrod VICK, Austin, TX (US)

(73) Assignee: American Innovations, Ltd., Austin, TX (US)

(21) Appl. No.: 18/969,016

(22) Filed: Dec. 4, 2024

Related U.S. Application Data
(60) Provisional application No. 63/605,859, filed on Dec. 4, 2023.

(51) Int. Cl. G01M 3/40; G06N 20/00

(52) U.S. Cl. CPC G01M 3/40; G06N 20/00

(57) ABSTRACT

Close interval survey methods and devices disclosed herein receive and filter waveform data obtained while an operator is performing a close interval inspection of a cathodic protection system including a cathodically protected underground pipeline. The waveform data is analyzed and assign to one of a plurality of bin categories based on the analysis. Scoring metrics for the waveform data may be generated and evaluated to determine whether a likelihood of the wave form data being “good”, i.e., in compliance with one or more predefined criteria, is less than a minimum sufficient likelihood. If the likelihood of good waveform data is below a specified minimum threshold hold, corrective action may be suggested to an operator while the operation is performing the close interval survey. In this manner, disclosed methods and systems actively guide the operating during performance of the close interval survey.

### CROSS REFERENCE TO RELATED APPLICATIONS

This application claims the benefit, pursuant to 35 USC § 119(e) of U.S. Application No. 63/605,859, filed Dec. 4, 2023, which is incorporated by reference herein in its entirety.

### TECHNICAL FIELD

The present disclosure pertains to cathodic protection systems for underground pipelines and, more specifically, corrosion surveys performed on such pipelines.

### BACKGROUND

Underground pipelines comprised of steel, carbon steel, and other metallic compositions are widely used to transport oil, natural gas, and other chemically stable fluids. An underground pipeline may be provisioned with a cathodic protection system (CPS) designed to mitigate pipeline corrosion that occurs whenever a metallic structure is placed in contact with an electrolytic medium such as soil. An impressed current CPS includes a rectifier coupled to the underground pipeline and configured to drive rectifier current into a metallic anode structure buried near the pipeline. The rectifier current changes the voltage across the pipeline-soil interface, thereby changing the electrochemical state of the pipeline to reduce or prevent corrosion. The voltage across the pipeline-soil interface, generally referred to as the pipe-to-soil potential, is monitored to confirm that cathodic protection systems are functioning as intended.

CPS effectiveness may be assessed by comparing pipe-to-soil potential values against industry standards such as National Association of Corrosion Engineers (NACE) standard SP0169-2013, Control of External Corrosion on Underground or Submerged Metallic Piping System. Regular testing of the effectiveness of a pipeline CPS is an important means of maintaining pipeline integrity and preventing future problems. One of the most common methods of testing a CPS is commonly referred to as an annual test station survey. A test station survey, also referred to herein simply as a survey for the sake of brevity, requires the measurement and recording of pipe-to-soil potentials at designated test stations each year. While test station surveys provide highly useful information, particularly for well-coated pipelines, test station survey data may cover less than 1% of a pipeline's surface and generally includes little, if any, pipe-to-soil potential data for pipeline locations of any considerable distance from the nearest test station.

Consequently, a procedure generally referred to within the industry as a close interval survey (CIS) has evolved. As suggested by its name, a CIS measures and records pipe-to-soil potential at regular intervals, e.g., every 3 to 6 feet, along a section of pipeline to provide data for assessing CPS effectiveness over the full length of the applicable pipeline. Periodic performance of a CIS is an integral part of maintaining safe pipeline operation and provides detailed information directly relevant to the pipeline's physical state. However, a CIS for a 1 mile section of pipeline typically includes more than 900 pipe-to-soil measurements, all or most of which are performed manually by one or more corrosion technicians who walk the pipeline from one end to the other, frequently in remote locations subject to extreme weather conditions. The U.S. Energy Information Administration estimated in 2021 there were roughly three million (3,000,000) miles of operational pipeline installed in U.S. soil for natural gas alone. If a thousand corrosion technician teams, working continuously 40 hours/week, were each able to take and record a valid new pipe-to-soil measurement every 15 seconds, a 6 foot interval CIS of the U.S. natural gas pipeline system would require more than 5 years to complete.

As a result of the significant time and expense required to perform a CIS for a pipeline of any considerable length, combined with the enormous quantity of installed pipeline, a CIS for any given segment pipeline is rarely taken more frequently than every few years. Thus, because a CIS is both extremely important and tremendously burdensome, it is vital to perform the CIS in manner that ensures valid data.

### SUMMARY

In accordance with teachings disclosed herein, disclosed subject matter improves the integrity of CIS data and the flow of CIS data from a field device such as a mobile PC to a record database such as a machine learning engine on an edge device. In at least some embodiments, the method encompasses multiple steps to validate the integrity of CIS data, obtained by field personnel using special electronics, and also to calculate a figure of merit by which survey data can be graded to assess whether the survey provides valid data and, if so, what actions need to be taken including, as an example, identifying specific geographic locations for which more detailed inspections are recommended.

Disclosed methods provide validation and analysis of CIS data contemporaneously with the survey, as opposed to a post-survey manual analysis requiring subsequent travel and set up by field personnel. This is important at least in part because a CIS survey is an expensive, slow, and logistically difficult proposition. Field personnel must be highly trained and must travel to remote locations and spend considerable time in environments that are often harsh to collect actionable survey data. If a CIS is negatively influenced by interference, improper processes, or malfunctioning tools, the invalidity of CIS data may be apparent, requiring a resurvey, or, worse yet, produce believable data leading to inaccurate conclusions and possibly hazardous situations as corrective action that could have been taken to avoid life-threatening situations is not completed in time.

Disclosed methods providing survey personnel with real-time analysis of the quality of CIS data as it is collected, enabling survey personnel to take corrective action to improve the quality of the data during the survey rather than redoing the survey later. This reduces cost as surveys are not redone multiple times. In at least some embodiments, disclosed methods calculate an overall figure of merit for the survey, which can improve survey personnel practices and reduce human error. Automatic analysis of anomalies using ML resources can quickly enable surveyors the ability to perform more detailed inspections and measurements while they are in the field, saving valuable time and cost and significantly reducing the likelihood of a re-survey.

In one aspect, close interval survey methods and devices disclosed herein receive and filter waveform data obtained while an operator is performing a close interval inspection of a cathodic protection system including a cathodically protected underground pipeline. The waveform data is analyzed and assign to one of a plurality of bin categories based on the analysis. Scoring metrics for the waveform data may be generated and evaluated to determine whether a likelihood of the wave form data being “good”, i.e., in compliance with one or more predefined criteria, is less than a minimum sufficient likelihood. If the likelihood of good waveform data is below a specified minimum threshold hold, corrective action may be suggested to an operator while the operation is performing the close interval survey. In this manner, disclosed methods and systems actively guide the operating during performance of the close interval survey.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an exemplary cathodic protection system in accordance with disclosed feature for performing guided corrosion surveys of underground pipelines;

FIG. 2 is a flow diagram for a field data device of performing guided corrosion surveys in accordance with disclosed subject matter;

FIG. 3 illustrates a method for employing and utilizing a scoring metric for a waveform data obtained during a corrosion survey;

FIG. 4 illustrates representative waveform data associated with different survey conditions or pipeline states;

### DETAILED DESCRIPTION

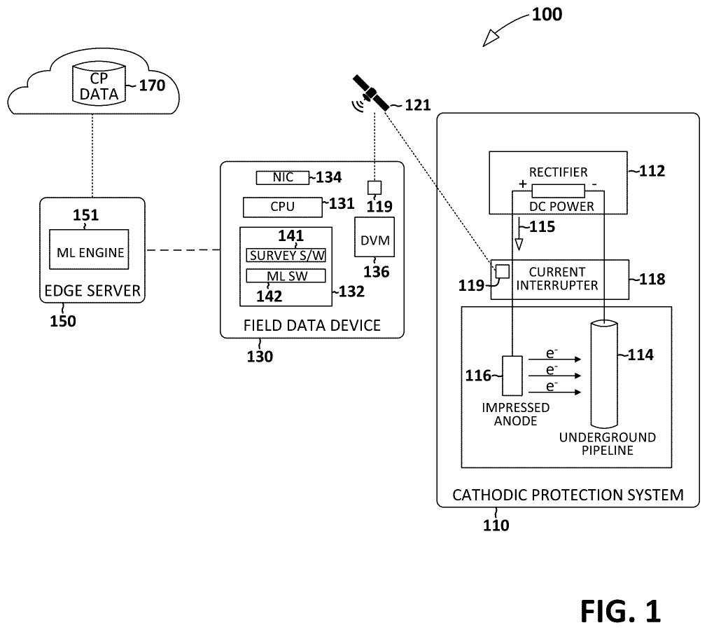

Exemplary embodiments and their advantages are best understood by reference to FIGS. 1-4, wherein like numbers are used to indicate like and corresponding parts unless expressly indicated otherwise.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

FIG. 1 illustrates a cathodic protection platform 100 including compute, storage, measurement, and communication resources for performing guided corrosion surveys of underground pipelines coupled to cathodic protection systems. The cathodic protection platform 100 illustrated in FIG. 1 includes an impressed current cathodic protection system 110, a field data device 130, an edge server 150, and a cloud-based cathodic protection database 170.

The impressed current cathodic protection system 110 illustrated in FIG. 1 includes a rectifier 112 connected between an underground pipeline 114 and an impressed anode 116 and configured to drive an impressed current 115 to impressed anode 116. A current interrupter 118 is coupled to rectifier 112 and configured to interrupt, when activated, the flow of impressed current 115 to impressed anode 116. The current interrupter depicted in FIG. 1 includes a GPS receiver 119 for receiving GPS data from one or more GPS satellites 121.

The field data device 130 depicted in FIG. 1 is a mobile computing device including hardware and/or software for measuring or otherwise acquiring cathodic protection survey data including, as an example, pipe-to-soil potential measurements, for underground pipeline 114. Field data device 130 may be implemented with a laptop computer or another type of mobile device configured with or communicatively coupled to suitable measurement resources such as a digital or analog multimeter or the like for taking electrical measurements. As depicted in FIG. 1, field data device 130 includes a central processing unit (CPU) 131 coupled to a processor-readable memory 132, a network interface card (NIC) 134, and a digital voltage meter 136. The memory 132 is configured to store data and processor-executable instructions that, when executed by CPU 131, cause field data device 130 to perform desired operations. The memory 132 illustrated in FIG. 1 includes guided corrosion survey software 141 and machine learning (ML) software 142 to support and assist field survey engineers and technicians performing close internal surveys or other types of corrosion surveys as described in more detail herein.

The illustrated cathodic protection platform 100 further includes an edge server 150 including a machine learning (ML) engine 151, coupled to a centralized, backend cathodic protection database 170. Although the cathodic protection database 170 illustrated in FIG. 1 is a cloud-based resource, other embodiments may employ a premises-based backend or a hybrid of cloud-based and premises-based.

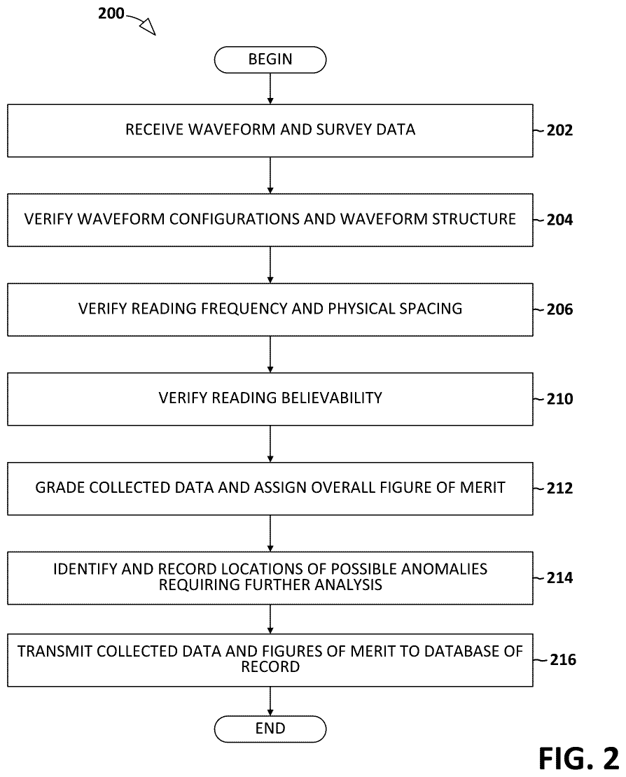

FIG. 2 illustrates an exemplary method 200 used in the performance of guided corrosion surveys in accordance with disclosed subject matter. One or more of the operations included in the illustrated method 200 may be performed by the field data device 130 and/or edge server 150 depicted in FIG. 1. The method 200 depicted in FIG. 2 begins with the receipt (operation 202) of waveform and survey data. As depicted in FIG. 2, the waveform configuration and structure are verified (operation 204). Verification of the waveform configuration and structure may include a comparison of the received waveform data against configuration and structure criteria developed based on historical and known good waveform data. Waveform configuration and structure criteria may specify one or more characteristics of the waveform and may include a machine learning based classification of the waveform. In such embodiments, waveforms may be classified into any one of several waveform categories including one or possibly more categories of known good waveforms and one or more categories of exception waveforms associated with one or more errors or exceptions.

The method 200 illustrated in FIG. 2 further includes a verification (operation 206) of reading frequency and physical spacing associated with survey data. In at least some embodiments, each survey reading is associated with a timestamp and GPS coordinates. Verification of reading frequency and physical spacing may ensure that the time intervals between readings at physically adjacent test points do not lie outside of historical values. Thus, for example, this verification may ensure that the difference in time between two adjacent test locations is consistent with the time required to take a reading at the first location, move the necessary test equipment to a second location, setup up the test equipment at the second location, and take a reading at the second location.

The illustrated method 200 further includes verifying (operation 210) a believability of each reading. In at least some embodiments, believability includes a comparison of one or more test readings against test value criteria developed from historical test reading data. For example, believability may determine whether a test reading lies within upper and lower threshold values for the applicable reading. Believability may further include one or more inter-reading believability criteria including, as an example, criteria corresponding to upper and/or lower limits on variations among two or more readings. Thus, for example, a believability exception may be raised if a group of readings exhibit abnormally low inter-reading variation, indicating a possible issue with the test equipment or testing procedure.

The illustrated method 200 further includes grading (operation 212) collected data and assigning and overall figure of merit to the collected data. In at least some embodiments, grading and/or the overall figure of merit may reflect a percentage of total readings that are verified against all of the previously identified verifications. In these embodiments, the grade and the overall figure of merit are indicative of the efficiency of the survey and an accuracy of the survey data. In some embodiments the grade and/or figure of merit may further include or indicate a suspected quality of the underground pipeline itself. Thus, for example, in at least some embodiments, the grading and figure of merit may indicate that efficient and accurate survey readings were collected from a “healthy” pipeline, efficient and accurate survey readings were collected from a pipeline of suspect quality, inefficient and potentially inaccurate readings were collected from a suspected healthy pipeline, and so forth. Grades and figures of merit may be determined based on historical data for the same and may be determined in accordance with one or more rules and/or criteria for grading and figures of merit. In at least one embodiment, grades may be determined for each verification operation illustrated in FIG. 2 including waveform configuration and structure, reading frequency and physical spacing, and believability.

The method 200 illustrated in FIG. 2 further includes identifying and recording (operation 214) one or more locations with potentially anomalistic readings, grades, or figures of merit that may require further analysis or further surveying. The illustrated method concludes with transmitting (operation 216) the collected data and figures of merit to centralized, back-end storage resource, whether cloud-based, on-premises, or a combination thereof.

Those of ordinary skill will recognize that the order in which the operations of method 200 are illustrated in FIG. 2 is exemplary and that sequence of operations may include additional or fewer operations and/or a different sequence of operations arranged in a different order.

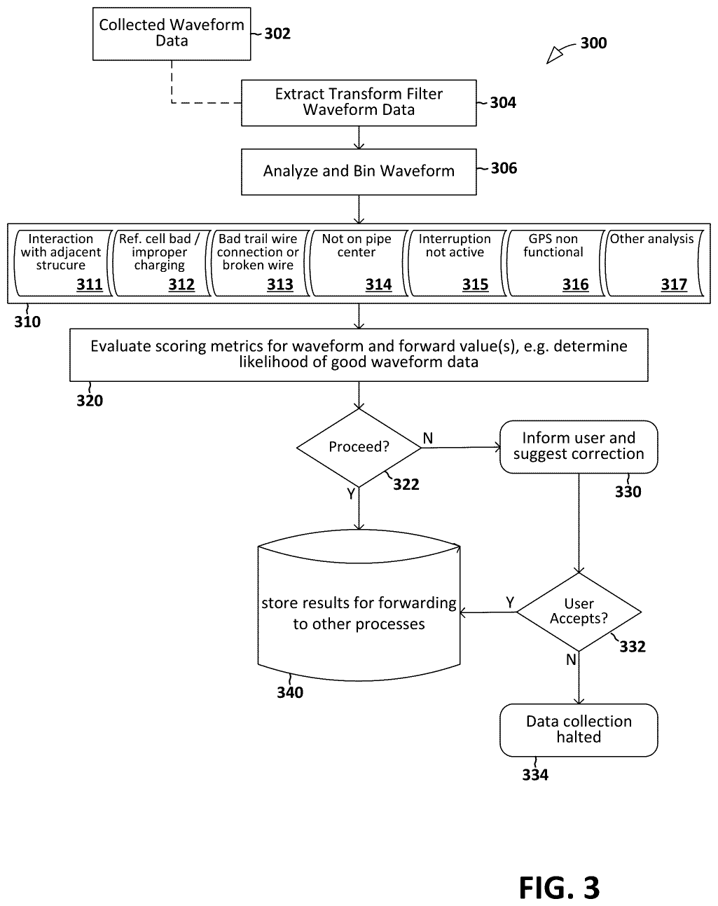

FIG. 3 illustrates an exemplary implementation for evaluating (operation 301) a received waveform. As depicted in FIG. 3, waveform data may be evaluated against historical waveform data and, for at least some waveforms that meet certain criteria, classified into any one or more exception categories.

As depicted in FIG. 3, method, 300 begins with the extracting, transforming, and/or filtering (operation 304) of collected waveform data 302 to produce processed data referred to herein simply as waveform data. The waveform data is then analyzed and binned (operation 306) into one of a plurality available bins 310. The bins available in the exemplary embodiment depicted in FIG. 3 include, as examples, an interaction with adjacent structure bin 311, a reference cell bad/improper charging bin, 312, a bad trail, wire connection or broken wire bin 313, a pipeline not on center bin, 314, an interruption not active bin 315, a GPS nonfunctional bin 316, and an other analysis bin 317. Those of ordinary skill will appreciate that the specific bins illustrated in FIG. 3 are exemplary, and that other implementations may include more, fewer, or different bins.

The method 300 illustrating FIG. 3 further includes evaluating (operation 320 scoring metrics for the waveform data and forwarding values indicative of a likelihood of good waveform data. If it is determined (operation 322) that the likelihood of good data is insufficient, the method 300 depicted in FIG. 3 branches to operation 330 to inform the user of one or more suspected exceptions and, in at least some embodiments, may suggest a corrective action to take. At operation 332, the user may elect to either accept or reject the suspect data or decline. If the user rejects the suspect data, data collection is halted (operation 334). If the user accepts the suspect data, the waveform results are stored (operation 340) for forwarding to other processes. Similarly, if it is determined in operation 322 that likelihood of good waveform data is acceptable, the illustrated method also proceeds to operation 340.

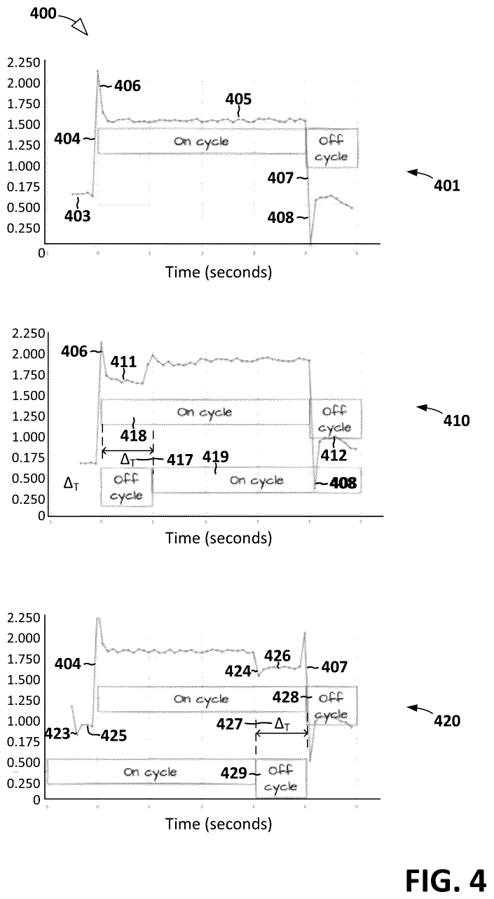

FIG. 4 illustrates exemplary waveforms corresponding to different suspect conditions that the guided corrosion resources disclosed herein may identify. In at least some embodiments, good waveform data is consistent with the waveform 401 depicted in FIG. 4. The good waveform 401 is characterized by two distinct and stable DC voltage values, including a first voltage value 403 prior to a low to high transition 404, and a second DC value 405 following the low to high transition and sudden but brief transient spikes including a first positive transient spike 406 at low to high transition 404 and a second negative transient spike 408 occurring at high to low transition 407. In contrast to waveform 401, first and second suspect waveforms 410 and 420 respectively are indicative of interference attributable to time differences between two neighboring potential transitions.

Suspect waveform 410 includes one or more additional DC levels including a third DC level 411 occurring for a short duration following positive transient spike 406 and a fourth DC level 412 occurring for a short duration following negative transient spike 408. These additional DC levels may reflect a time difference Δ_{T} (417) between the beginning of “on” cycles 418, 419 associated two adjacent or nearby interrupt mechanisms. Suspect waveform 420 includes an additional and brief negative transient spike 423 and a brief fifth DC level 425 preceding low to high transition 404 as well as an additional and brief negative transient spike 424 and a brief sixth DC level 426 occurring for a short duration preceding high to low transition 407. These additional transient spikes and DC levels may reflect a time difference Δ_{T} (427) between the beginning of “off” cycles 428, 429 associated two adjacent or nearby interrupt mechanisms.

Those of ordinary skill in the field of cathodic protection systems will recognize that the waveforms 401, 410, and 420 are merely exemplary and that other conditions may produce their own distinctive waveforms. These characteristic waveforms may be used in conjunction with a machine learning algorithm to train the machine learning algorithm.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A close interval survey method, comprising:
receiving and filtering waveform data obtained while performing a close interval inspection of a cathodic protection system including a pipeline;
analyzing the waveform data to assign the waveform data to one of a plurality of bin categories;
evaluating scoring metrics for the waveform data; and
responsive to determining, based on said evaluating, a likelihood of good wave form data is less than a minimum sufficient likelihood, suggesting corrective action to an operator while the operation is performing the close interval survey.

2. The method of claim 1, wherein the waveform data corresponds to one or more pipeline potential waveforms indicative of a pipe-to-soil (PTS) potential as a function of time.

3. The method of claim 1, wherein the bin categories consist of any one or more of:
an adjacent structure interaction bin;
a bad reference cell bin;
a bad trail wire bin;
an off-center bin;
a no interruption bin; and
a GPS failure bin.

4. The method of claim 3, wherein the suggesting corrective action includes suggesting the operator to move to a center of the pipeline.

5. The method of claim 1, wherein analyzing the waveform data includes identifying direct current (DC) voltage levels and transient voltage spikes of the PTS potential.

6. The method of claim 5, wherein the waveform data includes reflect PTS potential during one or more cathodic protection interrupt cycles.

7. The method of claim 6, wherein analyzing he waveform data includes identifying only two DC voltage levels for good waveform data.

8. The method of claim 7, further comprising: responsive to identifying one or more additional DC voltage levels determining a low likelihood of good waveform data.

9. A field data device, comprising:
a central processing unit (CPU);
a memory, accessible to the CPU, including processor executable instructions that, when executed by the CPU, cause the field data device to perform operations including:
receiving and filtering waveform data obtained while performing a close interval inspection of a cathodic protection system including a pipeline;
analyzing the waveform data to assign the waveform data to one of a plurality of bin categories;
evaluating scoring metrics for the waveform data; and
responsive to determining, based on said evaluating, a likelihood of good wave form data is less than a minimum sufficient likelihood, suggesting corrective action to an operator while the operation is performing the close interval survey.

10. The field data device of claim 9, wherein the waveform data corresponds to one or more pipeline potential waveforms indicative of a pipe-to-soil (PTS) potential as a function of time.

11. The field data device of claim 9, wherein the bin categories consist of any one or more of:
an adjacent structure interaction bin;
a bad reference cell bin;
a bad trail wire bin;
an off-center bin;
a no interruption bin; and
a GPS failure bin.

12. The field data device of claim 11, wherein the suggesting corrective action includes suggesting the operator to move to a center of the pipeline.

13. The field data device of claim 9, wherein analyzing the waveform data includes identifying direct current (DC) voltage levels and transient voltage spikes of the PTS potential.

14. The field data device of claim 13, wherein the waveform data includes reflect PTS potential during one or more cathodic protection interrupt cycles.

15. The field data device of claim 14, wherein analyzing he waveform data includes identifying only two DC voltage levels for good waveform data.

16. The field data device of claim 14, wherein the operation include: responsive to identifying one or more additional DC voltage levels determining a low likelihood of good waveform data.
